(19) United States
(12) Patent Application Publication
(10) Pub. No.: US 2024/0426149 A1
(43) Pub. Date: Dec. 26, 2024

(54) Door Lock

(71) Applicant: Jeff Chen, Chiayi County (TW)

(72) Inventor: Jeff Chen, Chiayi County (TW)

(21) Appl. No.: 18/746,073

(22) Filed: Jun. 18, 2024

(30) Foreign Application Priority Data
Jun. 20, 2023 (TW) 112123147

(51) Int. Cl. E05C 1/08; E05B 15/00

(52) U.S. Cl. CPC E05C 1/08; E05B 15/0006

(57) ABSTRACT

A door lock includes a lock latch, a first locking mechanism, and a second locking mechanism. The first locking mechanism and the second locking mechanism can be relatively screwed and tightened and assembled with the lock latch. The second locking mechanism includes an elastic buckle component and a ratchet portion, which can only be screwed and assembled in clockwise direction with the first locking mechanism due to the one-way engaging between the elastic buckle component and the ratchet portion. That is to say, through the design of the elastic buckle component and the ratchet portion of the second locking mechanism to engage with each other, the second locking mechanism can be prevented from being unscrewed relative to the first locking mechanism. This prevents the door lock from loosening due to children playing with it. In other words, the door lock of the present invention has the effect of preventing loosening.

### BACKGROUND OF THE PRESENT INVENTION

### Field of Invention

The present invention relates to a door lock, and in particular, to a door lock that utilizes a one-way engagement and abutment method between an elastic buckle component and a ratchet portion to prevent loosening.

### Description of Related Arts

There are many types of door locks on the market, such as Taiwan Patent Application Nos. 109112142, 109215408, and US patents U.S. Pat. No. 11,408,197 B2, US 2022/0162883.A1, etc. The door lock structures disclosed are often used in door locks for ordinary households. In order to achieve the purpose of convenient assembly, most assembly parts will be reduced and replaced by screwed assembly. Although the screwed method can facilitate the assembly of the door lock, it must be ensured that the door lock will not loosen after assembly. The present invention designs a door lock that prevents loosening.

### SUMMARY OF THE PRESENT INVENTION

Therefore, the purpose of the present invention is to provide a door lock that prevents loosening.

Therefore, the door lock of the present invention is assembled on a door panel, which has a first board surface, a second board surface, a side edge, and an assembly hole penetrating the first board surface and the second board surface, wherein the door lock includes a lock latch, first locking mechanism and second locking mechanism; wherein the lock latch is assembled on the side edge of the door panel and extends into the assembly hole; wherein the first locking mechanism is assembled in the assembly hole from the first board surface of the door panel and is properly assembled with the lock latch, and which includes a first positioning cylinder passes through the assembly hole, wherein the first positioning cylinder has an external thread portion formed thereon; wherein the second locking mechanism is assembled in the assembly hole from the second board surface of the door panel and is properly assembled with the lock latch, and which includes a second positioning cylinder, an outer seal cover, an elastic buckle component, and a rotating lock component, respectively, arranged thereon, wherein the second positioning cylinder is hollow and has an internal thread portion and a ratchet portion formed on an inner edge thereof, respectively, wherein the internal thread portion is capable of being screwed relative to the external thread portion, wherein the outer seal cover is capable of being assembled in the second positioning cylinder, and has an axis hole formed thereof and a positioning groove located at the periphery thereof, wherein the positioning groove corresponds to the ratchet portion, the elastic buckle component is assembled in the positioning groove and engages with the ratchet portion, and the rotating lock component passes through the outer seal cover and is assembled with the lock latch.

when the second locking mechanism is assembled relative to the first locking mechanism, the second positioning cylinder is screwed relative to the first positioning cylinder, so that the internal thread portion and the external thread portion are relatively screwed and tightened, and during the tightening process, the elastic buckle component contacts the ratchet portion in a clockwise direction, and when the second positioning cylinder rotates counterclockwise relative to the first positioning cylinder, the elastic buckle component resists the ratchet portion in the opposite direction. Through the design of the clastic buckle component and the ratchet portion of the second locking mechanism to engage with each other, the second positioning cylinder can be prevented from unscrewing relative to the first positioning cylinder, and the door lock can be prevented from loosening due to children's playing or use for a period of time; that is to say, the door lock of the present invention has the effect of preventing loosening.

### BRIEF DESCRIPTION OF THE DRAWINGS

FIG. 1 is an exploded view of a door lock and door panel according to a preferred embodiment of the present invention.

FIG. 2 is an exploded view of the second locking mechanism of the door lock according to the preferred embodiment of the present invention.

FIG. 3 is a front exploded view of the outer seal cover and the elastic buckle component of the second locking mechanism of the door lock according to the preferred embodiment of the present invention.

FIG. 4 is a front view of the elastic buckle component assembled on the outer seal cover according to the preferred embodiment of the present invention.

FIG. 5 is a front view of the second positioning cylinder according to the preferred embodiment of the present invention.

FIG. 6 is a rear view after the outer seal cover, elastic buckle component, rotating lock component, positioning component and second positioning cylinder of the second locking mechanism, according to the preferred embodiment of the present invention, are assembled with each other.

FIG. 7 is an exploded view of the second locking mechanism according to the preferred embodiment of the present invention.

FIG. 8 is a partial sectional view of the second locking mechanism according to the preferred embodiment of the present invention.

### DETAILED DESCRIPTION OF THE PREFERRED EMBODIMENT

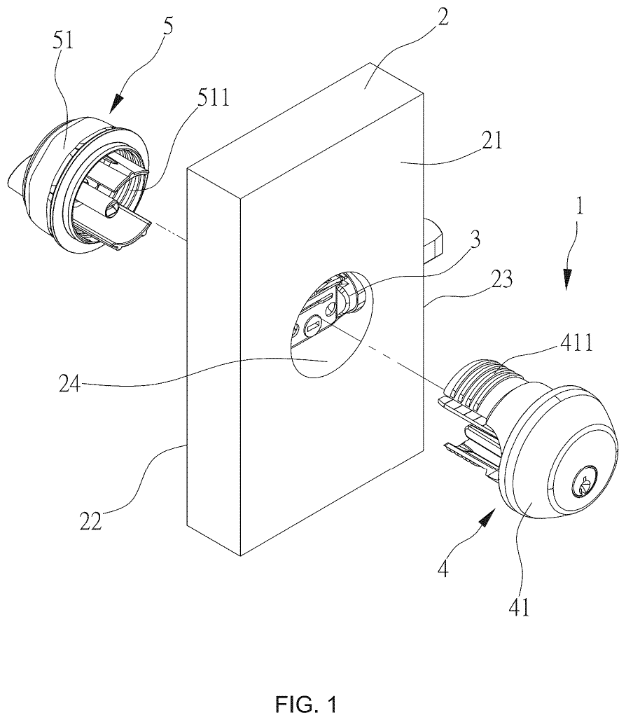

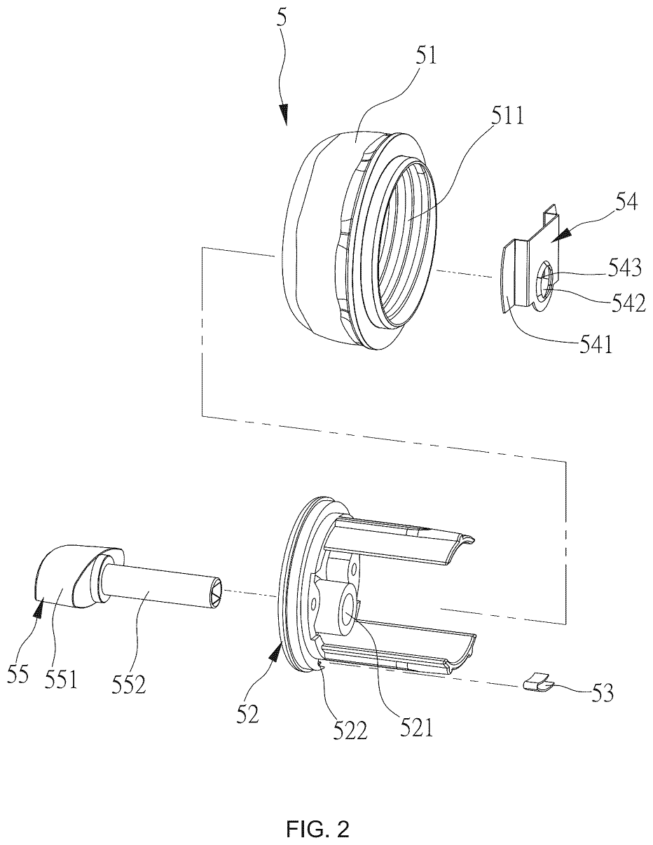

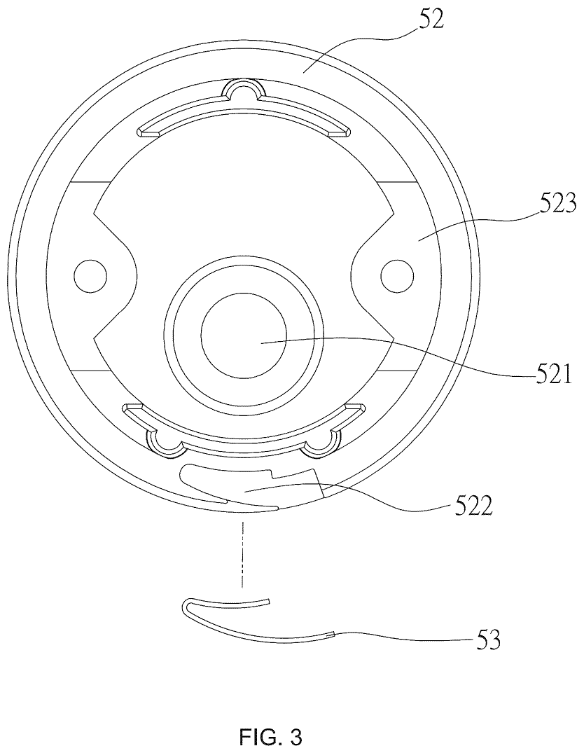

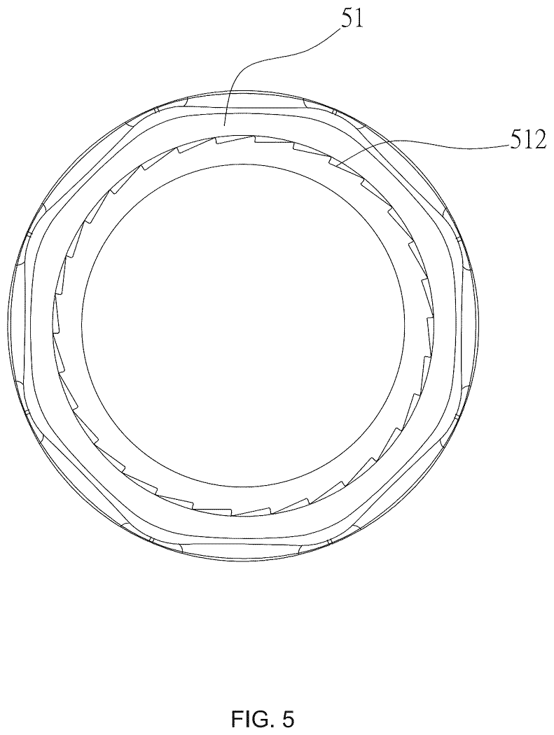

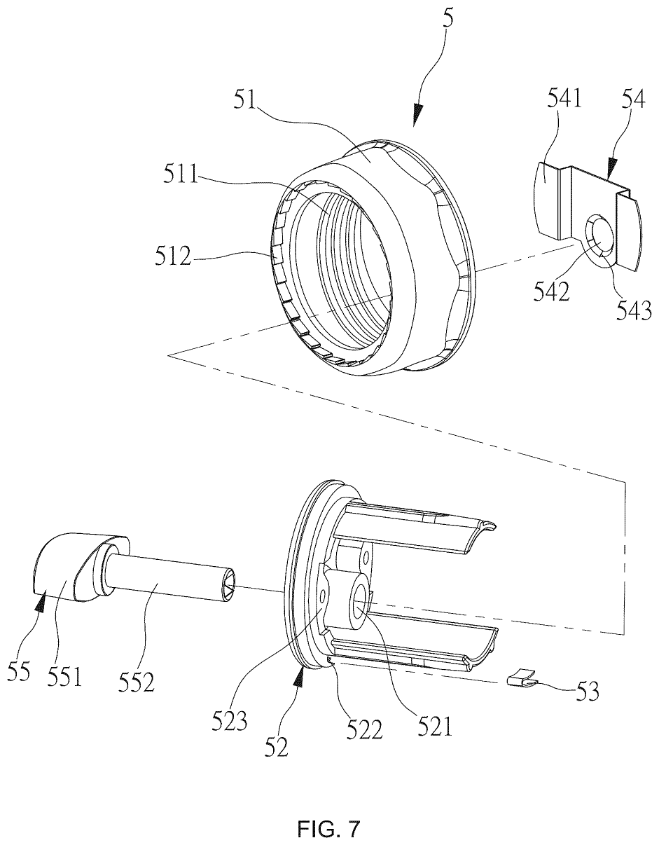

Referring to FIGS. 1-8, a door lock 1 according to a preferred embodiment of the present invention is assembled on a door panel 2. The door panel 2 has a first board surface 21, a second board surface 22, a side edge 23, and an assembly hole 24 passing through the first board surface 21 and the second board surface 22. The door lock 1 includes a lock latch 3, a first locking mechanism 4, and a second locking mechanism 5 respectively arranged thereon. The lock latch 3 is assembled in the side edge 23 of the door panel 2 and extends into the assembly hole 24. The first locking mechanism 4 is assembled in the assembly hole 24 from the first board surface 21 of the door panel 2 and is properly assembled with the lock latch 3. The first locking mechanism 4 includes a first positioning cylinder 41 that passes through the assembly hole 24. The first positioning cylinder 41 has an external thread portion 411 formed thereon. The second locking mechanism 5 is assembled in the assembly hole 24 from the second board surface 22 of the door panel 2 and is properly assembled with the lock latch 3, and includes a second positioning cylinder 51, an outer seal cover 52, an elastic buckle component 53, a positioning component 54 and a rotating lock component 55 respectively arranged thereon. The second positioning cylinder 51 is hollow and has an internal thread portion 511 and a ratchet portion 512 formed on an inner edge thereof, respectively. The internal thread portion 511 is capable of being screwed relative to the external thread portion 411. The outer seal cover 52 is capable of being assembled in the second positioning cylinder 51, and has an axis hole 521 formed thereof, a positioning groove 522 arranged at the periphery thereof, and two accommodating areas 523 arranged at both sides of the axis hole 521. The positioning groove 522 corresponds with the ratchet portion 512. The elastic buckle component 53 is assembled in the positioning groove 522 and is interlocked with the ratchet portion 512. The positioning component 54 has two side wings 541, a magazine hole 542 in the central portion, and a plurality of cutouts 543 located at the hole edge of the magazine hole 542 to make the magazine hole 542 elastic. The two side wings 541 are respectively disposed in the two accommodating areas 523, and the axis hole 521 axially corresponds to the magazine hole 542. The rotating lock component 55 has a rotating piece 551 and a pivot shaft 552, and the diameter of the pivot shaft 552 is slightly larger than the diameter of the magazine hole 542. The pivot shaft 552 passes through the axis hole 521 of the outer seal cover 52 and the magazine hole 542, and connects to the lock latch 3. At this time, the pivot shaft 552 is sandwiched by the magazine hole 542, limiting the axial displacement of the rotating lock component 55.

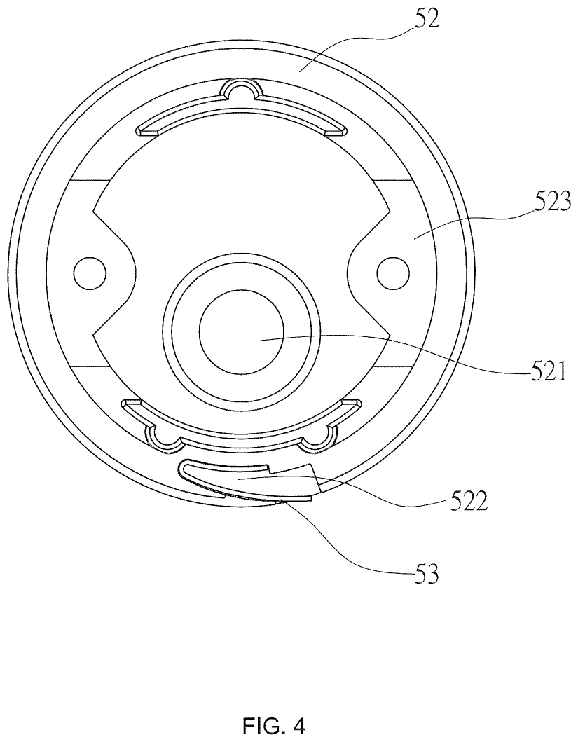

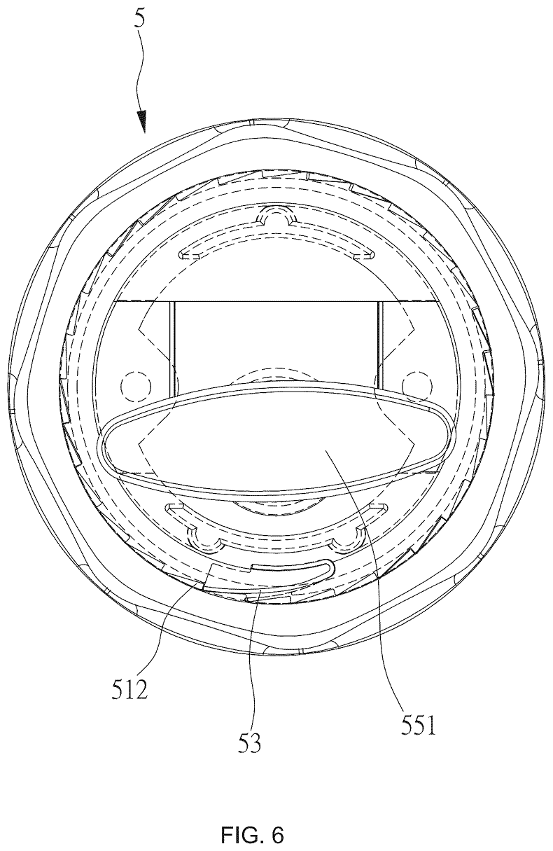

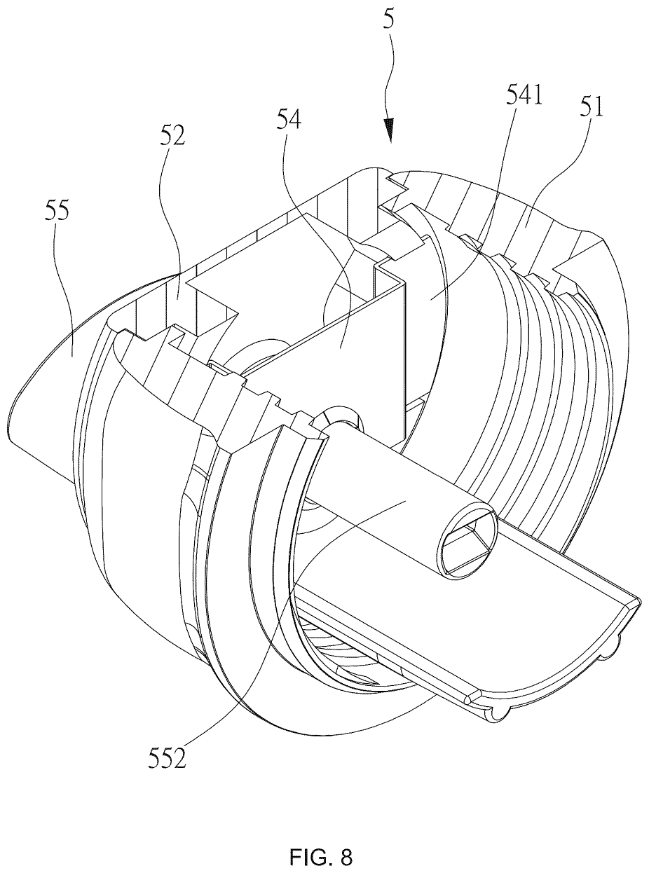

When assembling the second locking mechanism 5, the elastic buckle component 53 is first assembled in the positioning groove 522 as shown in FIG. 4. Then, the outer seal cover 52 is assembled in a hollow part of the second positioning cylinder 51 as shown in FIG. 8. At this time, the elastic buckle component 53 engages and abuts against the ratchet portion 512 as shown in FIG. 6. Then, the pivot shaft 552 of the rotating lock component 55 is assembled in the axis hole 521. Finally, as shown in FIG. 8, the positioning component 54 is sleeved on the pivot shaft 552, and the two side wings 541 are placed in the corresponding accommodating areas 523. This completes the assembly of the second locking mechanism 5.

In the process of assembling the door lock 1 to the door panel 2 of the present invention, first the lock latch 3 is installed in the assembly hole 24, and then the first locking mechanism 4 and the second locking mechanism 5 are sequentially assembled in the assembly hole 24, and is properly connected with the lock latch 3, and then the second positioning cylinder 51 is screwed relative to the first positioning cylinder 41, so that the internal thread portion 511 and the external thread portion 411 are screwed tightly relative to each other. During the tightening process, the elastic buckle component 53 contacts the ratchet portion 512 in the clockwise direction, thereby producing the sound of the elastic buckle component 53 contacting the ratchet portion 512. When the second positioning cylinder 51 is screwed tightly relative to the first positioning cylinder 41, the assembly of the door lock 1 is completed.

The present invention is designed by the elastic buckle component 53 and the ratchet portion 512 of the second locking mechanism 5 to engage with each other. When the second positioning cylinder 51 rotates counterclockwise relative to the first positioning cylinder 41, the elastic buckle component 53 resists the ratchet portion 512 in the opposite direction, which prevents the second positioning cylinder 51 from unscrewing relative to the first positioning cylinder 41. This prevents the door lock 1 from loosening due to children playing it or using it for a period of time. In other words, the door lock 1 of the present invention has the effect of preventing loosening. In addition, due to a radial elastic resistance force between the elastic buckle component 53 and the ratchet portion 512 of the second positioning cylinder 51, the outer seal cover 52 and the second positioning cylinder 51 can be assembled more tightly, further improving the assembly quality of the second locking mechanism 5 of the door lock 1. Further, by the positioning component 54 being sleeved on the pivot shaft 552 and resisting the accommodating areas 523, so that the rotating lock component 55 and the outer seal cover 52 can be quickly assembled with the second positioning cylinder 51, and also have the effect of convenient assembly in the assembly of the door lock 1.

It is worth further explaining that the design of the elastic buckle component 53 and the ratchet portion 512 of the door lock 1 of the present invention has the effect of preventing loosening. However, an additional mechanism for releasing the mutual engagement between the elastic buckle component 53 and the ratchet portion 512 may be provided in practical product design so that the door lock 1 can be easily disassembled when replacing the door lock 1. Since the mechanism for releasing the engagement is not a feature of the present invention, it will not be further described in the present invention.

What is claimed is:

1. A door lock, which is assembled on a door panel, wherein the door panel has a first board surface, a second board surface, a side edge, and an assembly hole that penetrates through the first board surface and the second board surface, wherein the door lock comprises:
a lock latch, which is assembled on the side edge of the door panel and extends into the assembly hole;
a first locking mechanism, which is assembled in the assembly hole from the first board surface of the door panel and is properly assembled with the lock latch, and which comprises a first positioning cylinder that passes through the assembly hole, wherein the first positioning cylinder has an external thread portion formed thereon; and
a second locking mechanism, which is assembled in the assembly hole from the second board surface of the door panel and is properly assembled with the lock latch, and which comprises a second positioning cylinder, an outer seal cover, an elastic buckle component, and a rotating lock component, respectively, arranged thereon, wherein the second positioning cylinder is hollow and has an internal thread portion and a ratchet portion formed on an inner edge thereof, respectively, wherein the internal thread portion is capable of being screwed relative to the external thread portion, wherein the outer seal cover is capable of being assembled in the second positioning cylinder, and has an axis hole formed thereof and a positioning groove located at the periphery thereof, wherein the positioning groove corresponds to the ratchet portion, the elastic buckle component is assembled in the positioning groove and engages with the ratchet portion, and the rotating lock component passes through the outer seal cover and is assembled with the lock latch;
when the second locking mechanism is assembled relative to the first locking mechanism, the second positioning cylinder is screwed relative to the first positioning cylinder, so that the internal thread portion and the external thread portion are relatively screwed and tightened, and during the tightening process, the elastic buckle component contacts the ratchet portion in a clockwise direction, and when the second positioning cylinder rotates counterclockwise relative to the first positioning cylinder, the elastic buckle component resists the ratchet portion in the opposite direction.

2. The door lock, as recited in claim 1, wherein the outer seal cover further has two accommodating areas formed on both sides of the axis hole, wherein the second locking mechanism further has a positioning component, wherein the positioning component has two side wings formed on both sides thereof and a magazine hole arranged in the central portion thereof, wherein the two side wings are respectively disposed in the two accommodating areas, and the magazine hole is axially corresponding to the axis hole, and the rotating lock component passes through the axis hole and the magazine hole in sequence and is connected with the lock latch, and the rotating lock component is clamped by the magazine hole to limit the axial displacement of the rotating lock component.
